(19) United States
(12) Patent Application Publication
(10) Pub. No.: US 2010/0008377 A1
(43) Pub. Date: Jan. 14, 2010

(54) QUEUE MANAGEMENT BASED ON MESSAGE AGE

(75) Inventors: Srinivas Hasti, Stamford, CT (US); Michael J. Spreitzer, Croton-on-Hudson, NY (US); Graham D. Wallis, West Wellow (GB); David Ware, Redlynch (GB); Neil G.S. Young, Southampton (GB)

Correspondence Address: Cantor Colburn LLP-IBM Europe, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/169,319

(22) Filed: Jul. 8, 2008

(51) Int. Cl. H04L 12/28

(52) U.S. Cl. 370/412

(57) ABSTRACT

A system for managing inbound messages in a server complex including one or more message consumers. The system includes a server configured to receive the inbound messages from a first peripheral device and to transmit messages to one or more of the plurality of message consumers. The system also includes an inbound message queue coupled to the server, the inbound message queue configured to store inbound message and discard at least one message when an age of the message exceeds an expiration time.

### BACKGROUND

1. Field of the Invention

The present disclosure relates generally to computing devices, and, in particular, to managing an inbound message queue in a computing device.

2. Description of the Related Art

An asynchronous messaging system handles request messages that represent inbound work (requests) for a server complex that includes message consumers. Request messages are received onto queues and then dispatched to the message consumers. The request messages may require a response or may represent one-way notifications that do not require a response. Examples of one-way notifications may include, for example, a submission of data from a remote sensor that is to be checked/recorded.

Response time refers to the time taken to process the request message—i.e. how long has the request message had to wait on the request queue (and associated transmission queues in the messaging system) before it is delivered to the message consumer. The response time does not relate to the (optional) generation or receipt of a response message. The overall rate at which work is accepted into the server complex has to be managed, otherwise long response times may occur.

Often, producers of request messages use message expiration to address the long response times. For example, if a request message takes too long to process then it will expire and the requester will either time out or receive an expiry report message (depending on the option selected by the requesting application).

Unfortunately, the expiration times are set by the requesting applications (clients) but the clients are not aware of the overall load on the backend server complex or of the response times being experienced by messages other than their own. The clients have only a partial view of the current load characteristics and cannot set expiry times to suit the server complex as a whole. There is no incentive for an application to unilaterally shorten expiration times. For example, this will result in reducing the level of service that an application receives while not affecting any other applications. Of course, many other solutions exist in the art, but typically each of them may have their own shortcomings.

Accordingly, what are needed are techniques for effective management of messages stored within a queue.

### BRIEF SUMMARY

In one embodiment, the invention includes an asynchronous messaging system for managing inbound messages, the messages including work requests, in a server complex including one or more message consumers, the system including: a server configured to receive the inbound messages from a first peripheral device, assign an expiration time for each of the messages according to a load and to transmit messages to the one or more message consumers; and an inbound message queue coupled to the server, the inbound message queue configured to store inbound message until an age of at least one message stored on the inbound message queue exceeds an associated expiration time.

In another embodiment, the invention includes a method of managing inbound messages at a server of an asynchronous messaging system, the method including: using at least one of the system including the server and application stored in the system to determine an expiration time for at least one message on an inbound message queue coupled to the server and assigning the expiration time for each of the messages with the server; and discarding the at least one message at or after the expiration time.

In yet another embodiment, the invention includes a computer program product for managing inbound messages at a server of an asynchronous messaging system, the computer program product including: a computer-readable storage medium for storing instructions for executing the management of inbound messages at a server, the management of inbound messages at a server including a method of: determining an expiration time of at least one message on an inbound message queue coupled to the server; and discarding the at least one message at or after the expiration time.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts a system according to one embodiment of the present invention; and

FIGS. 2A and 2B, collectively referred to herein as FIG. 2, are flow charts depicting a method according to one embodiment of the present invention.

The detailed description explains the preferred embodiments of the invention, together with advantages and features, by way of example with reference to the drawings.

### DETAILED DESCRIPTION

Embodiments of the present invention may overcome some or all of the problems associated with the prior art by keeping track of at least one temporal aspect of a message on a queue, and discarding the at least one message from the queue according to an associated or designated expiration time for the message.

Of course, expiration times, age and other terms (such as duration or life) may be considered to be generally relative terms and interchangeable in manners known in the art. For example, the system 100 may associate an inception time with a message, calculate an age on an ongoing basis, and determine an expiration time (for example, a time associated with real time), or a duration (such as a lifetime for the message). Accordingly, it should be recognized that each of these temporal terms may bear some relation to the others, and in fact be generally interchangeable.

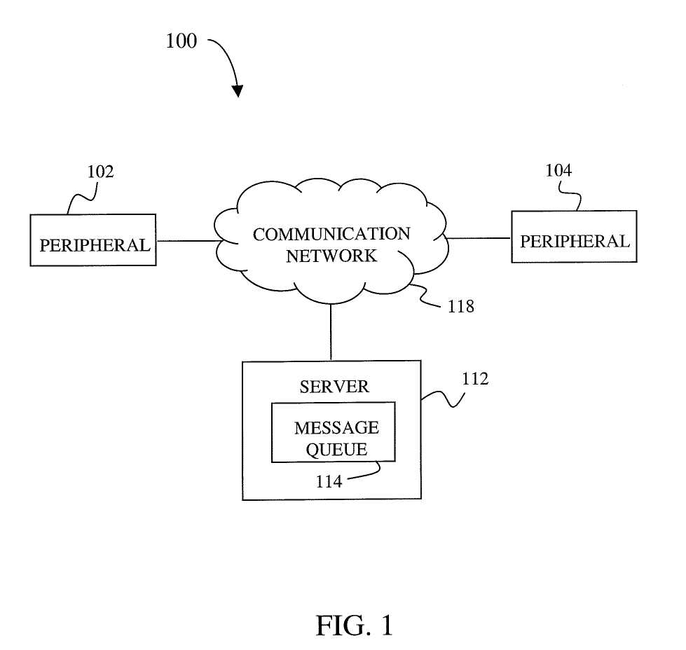

FIG. 1 shows an example of a system 100 according to an embodiment of the present invention. The system includes first and second peripheral devices 102 and 104, respectively. Each peripheral device 102 and 104 may be implemented using a general-purpose computer executing a computer program for carrying out the processes described herein. The peripheral devices 102 and 104 may be a personal computer (e.g., a lap top, a personal digital assistant) or a host attached terminal. Of course, the system 100 could include many more peripheral devices and is not limited to peripheral devices. Of course, the peripheral devices are not limited to being personal computers and may be any device capable of creating a message to be transferred to another device. Further examples of such devices include sensors that report data.

The first and second peripheral devices 102 and 104, respectively, are coupled to each other and a server 112 via a communications network 118. The communications network 118 may be any type of known network including, but not limited to, a wide area network (WAN), a public switched telephone network (PSTN) a local area network (LAN), a global network (e.g. Internet), a virtual private network (VPN), and an intranet. The communications network 118 may be implemented using a wireless network or any kind of physical network implementation known in the art. Peripheral devices 102 and 104 may be coupled to the server 112 through multiple networks (e.g., intranet and Internet) so that not all user systems are coupled to the host systems 104 through the same network. One or more user systems and the server 112 may be connected to the network 118 in a wireless fashion.

The server 112 depicted in FIG. 1 may be implemented using one or more servers operating in response to a computer program stored in a storage medium accessible by the server 112. The server 112 may operate as a network server (e.g., a web server) to communicate with the user systems 102 and 104. The server 112 handles sending and receiving information to and from the peripheral devices 102 and 104 and can perform associated tasks. The server 112 may also include firewalls to prevent unauthorized access and enforce any limitations on authorized access. For instance, an administrator may have access to the entire system and have authority to modify portions of the system. A firewall may be implemented using conventional hardware and/or software as is known in the art.

The server 112 may also include a message queue 114. The message queue 114 may be part of the server 112 as shown or may be a standalone unit. The message queue 114 may, in some embodiments, be an inbound message queue that stores inbound messages until they are delivered to a message consumer. For example, the first peripheral device 102 may generate a message for delivery to the second peripheral device 104. The message may be received, via the communications network 118, by the server 112 and stored in the message queue 114 until it may delivered to the second peripheral device 104.

FIG. 1 shows only two peripheral devices 102 and 104. Of course, according to embodiments of the present invention, the number of peripheral devices is not limited to two and the system 100 may include any number of peripheral. As such, the message queue 114 may store messages from any number of peripheral for delivery to any number of message consumers.

The message queue 114 may be of predetermined length. That is, the message queue 114 may be able store messages until the length is met. After this point, old messages may be rejected. As discussed above, to be able to handle burst traffic, the length of the message queue 114 must be relatively long and when the queue is full a significant amount of memory may be consumed by the messages. This may lead to the attendant problems described above.

It should be understood that the system 100 may also include multiple message queues. In some embodiments, the amount of time a particular message has spent on any message queue is summed to determine the age of a message. Generally, the expiration time of the message is usually stored in the message. This avoids the need to aggregate the times that the message spends on different queues or within other parts of the system, as it can simply be compared with a standard, such as a system time (i.e., the current time).

In embodiments of the invention, the system 100 that is receiving request messages and classifying them is aware of the loads on all the backend servers 112 and has visibility to all the requesting (and associated response) messages in the system 100. The system 100 can “see” all the message flows and can apply aggregate control. The system 100 therefore imposes an expiration time on each request message as necessary (e.g. the system 100 can shorten or lengthen the expiration time, according to, for example, a processing load, an extent of message traffic or similar bases).

In more detail, two embodiments of the invention are described. In a first embodiment, message producers are explicitly requesting (and therefore are expecting) that messages can expire. In the second embodiment, the producers are not explicitly requesting expired messages but can retry or abandon an operation and therefore are not troubled by a system-initiated expiration of a message. A characteristic behavior is therefore that older messages on the queue can be discarded, making room for newer (fresher) messages. This behavior is suitable for data that goes stale and/or is superseded by more recent messages. This may be preferable over allowing the message producers to set the expiration times because the system 100 is better informed about the state of the queue and the response rates of the message consumers. This system 100 generally includes a message queue 114 long enough to handle traffic bursts, and avoids queue growth that would result in a time-consuming backlog of messages. Queue growth is generally restricted by discarding older messages by shortening their expiration times.

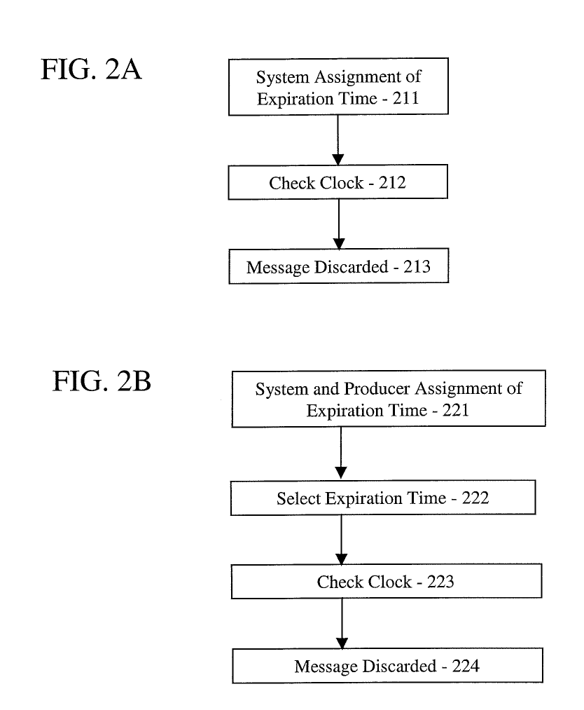

There are various ways in which the system 100 can implement the invention. Referring now to FIGS. 2A and 2B, aspects of the two embodiments are shown.

In FIG. 2A, a system-enforced expiration time can be used to replace an application-requested expiration time. This way is simple and efficient, it can be performed within the existing message design, thus avoiding additional data copying.

More specifically, in FIG. 2A, an age (from another perspective, the expiration time) of each message may be tracked. In this embodiment, in a first stage 211, the system 100 assigns an expiration time to each message, regardless of application requests. In a second stage 212, the system 100 checks a clock and compares the age to the expiration time. In a third stage 213, when the expiration time passes, the message is discarded.

In another embodiment, both expiration times may be stored in or alongside the message and the system 100 operates on the lesser of the two. The advantage of the latter technique is that the system 100 is better able to respond to improvements in the responsiveness of the backend servers. This results in relaxation of the system-enforced expiration time and restoration of the application requested expiration time. This is not feasible with the embodiment that uses replacement. However, the latter technique is more costly to implement, and requires storage of the additional time field with the message.

Aspects of this embodiment are depicted in FIG. 2B. In FIG. 2B, in a first stage 221, system assigned expiration times and producer assigned expiration times are assigned to a message. In a second stage 222, the system selects a lesser (or greater) of the two expiration times. In a third stage 223, the system 100 checks a clock and compares the age to the expiration time. In a fourth stage 224, when the expiration time passes, the message is discarded.

In a similar embodiment, in a first stage, a processing rate (or other such parameter) of messages is determined. In the next stage, if the processing rate is below a certain value, a given expiration time is assigned. As at least one alternative, if the processing rate is above a certain value, a different expiration time is assigned. In this manner, simple to complex algorithms for determining and assigning expiration times may be had.

The characteristics of either embodiment provide that when the backend server complex is overloaded and is not processing request messages sufficiently quickly, then the system-enforced expiration time can be shortened and messages that have been queued for too long expire. Newer messages are still accepted into the system. In general, it is the older messages that expire. It should be noted that in some embodiments, the producer may have set a short expiration time on a recent message and the message may therefore expire before an older message with a longer expiration time. Therefore, it is not always true that the older messages expire first. In that regard, it may be understood that a message that has been queued for too long expires, wherein the standard for what is “too long” may be determined by external standards, and are not necessarily dependent upon expiration times assigned to other messages. The solution is therefore appropriate to data streams in which older (stale) data is of less value compared to newer (fresh) data. Consider some examples of advantageous implementations of the system 100.

In one implementation, messages report data from a real-time sensor, in which more recent readings are more interesting or valuable. As load on the backend server complex eases, the system-enforced expiry time is relaxed and messages are allowed to remain queued for longer periods of time. The implementation that keeps both the system-enforced expiry time and the original application-requested expiry time is also able to restore the original application-requested expiry time if the system-enforced time is relaxed to the extent that it becomes greater than the application-requested time. That implementation therefore exhibits better fidelity and finer granularity. Neither implementation results in any synchronous “pushback” to the requesting applications or intermediaries.

In another embodiment, a system-enforced expiration time can be used even when requesting applications are not setting expiration times. This is possible provided the requesting applications are able to handle unexpected expiration, such as those with no associated report message/event. Examples include applications exhibiting timing out of the request within the application that issued it. This works trivially for notification style (unidirectional) messages, in which the application uses a fire-and-forget pattern.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An asynchronous messaging system for managing inbound messages, the messages comprising work requests, in a server complex including one or more message consumers, the system comprising:
a server configured to receive the inbound messages from a first peripheral device, assign an expiration time for each of the messages according to a load and transmit messages to the one or more message consumers; and
an inbound message queue coupled to the server, the inbound message queue configured to store inbound messages until an age of at least one message stored on the inbound message queue exceeds an associated expiration time.

2. The system of claim 1, wherein the server is configured to discard a message if the age of the message reaches the associated expiration time.

3. The system of claim 1, wherein the age of the at least one message includes a sum of times the at least one message remained on the inbound message queue and another message queue.

4. The system of claim 1, wherein the server is connected to the first peripheral device by a communications network.

5. The system of claim 4, wherein the communications network is the Internet.

6. The system of claim 1, further comprising:
the first peripheral device; and
a second peripheral device.

7. A method of managing inbound messages at a server of an asynchronous messaging system, the method comprising:
using the server, determining an expiration time for at least one message on an inbound message queue coupled to the server and assigning the expiration time for each of the messages with the server; and
discarding the at least one message at or after the expiration time.

8. The method of claim 7, further comprising: receiving an inbound message.

9. The method of claim 7, further comprising: determining the expiration time according to an age of the at least one message.

10. The method of claim 7, wherein an age of the at least one message includes a time the at least one message has spent on the inbound message queue.

11. The method of claim 10, wherein the age of the at least one message also includes a time the at least one message spent on another message queue.

12. The method of claim 7, further comprising evaluating a load and using the load for determining the expiration time.

13. The method of claim 7, further comprising using an external standard for determining the expiration time.

14. A computer program product for managing inbound messages at a server of an asynchronous messaging system, the computer program product comprising:
a computer-readable storage medium for storing instructions for executing the management of inbound messages at a server, the management of inbound messages at a server comprising a method of:
determining an expiration time of at least one message on an inbound message queue coupled to the server; and
discarding the at least one message at or after the expiration time.

15. The computer program product of claim 14, wherein the method further comprises: receiving an inbound message.

16. The computer program product of claim 14, wherein the method further comprises: assigning the expiration time by at least one of a system comprising the server and an application stored in the system.
